(19) United States
(12) Patent Application Publication
(10) Pub. No.: US 2002/0158528 A1
(43) Pub. Date: Oct. 31, 2002

(54) Vibration motor

(76) Inventors: Toshiaki Tsuzaki, Tottori (JP); Eiichi Ibata, Tottori (JP)

Correspondence Address: RATNER AND PRESTIA, Suite 301, One Westlakes, Berwyn, P.O. Box 980, Valley Forge, PA, 19482-0980, US

(21) Appl. No.: 10/066,930

(22) Filed: Feb. 4, 2002

(30) Foreign Application Priority Data
Feb. 6, 2001 (JP) 2001-029094

(51) Int. Cl. H02K 7/06; H02K 7/10

(52) U.S. Cl. 310/81

(57) ABSTRACT

An unbalance weight of a vibration motor includes a rest section for receiving a rotary shaft and a caulking section for caulking the unbalance weight to the rotary shaft. The rotary shaft includes a recess at a place corresponding to the rest section. Caulking strength applied to the caulking section forces parts of the weight to bite inside of the recess, thereby fixing the weight to the rotary shaft. This structure allows the rotary shaft to hold the weight tightly. The vibration motor can be mounted to a radio paging-device or a cellular phone, so that the user can sense the vibrations to be informed of a calling or a message arrival. The vibration motor is thus suited for a source of vibrations.

### TECHNICAL FIELD

The present invention relates to a structure of a vibration motor, mounted to a radio paging-device or a cellular phone, informing a user of a calling or a message arrival by making the user sense vibrations.

### BACKGROUND ART

A radio paging-device such as a pager has informed a user of a calling by sound; however, the sound sometimes jars on ears of other persons, e.g., attending a meeting. Instead of the sound, vibrations are used for informing only a user of a calling. A vibration motor, as a source of vibrations, is thus mounted to a radio paging-device. The motor has an unbalance weight mounted to a rotary shaft, and rotating the motor causes the weight to rotate, thereby producing vibrations. Radio paging-devices have been downsized because batteries and other parts have been downsized, and a card-size radio paging-device is now available on the market. The market demands a more compact and thinner device, therefore, a vibration motor is required to be further downsized and yet produce greater vibrations.

A structure of a conventional vibration motor is described hereinafter. FIG. 6 is a perspective view of a conventional vibration motor, and FIG. 7 is a partial sectional view of the motor shown in FIG. 6. In FIG. 6, rotary shaft 102 of motor 101 is journaled by bearing 103. Rotary shaft 102 has unbalance weight 104 at its tip. Unbalance weight 104 has groove 106 axially, and rotary shaft 102 is placed in groove 106. Caulking section 141 on the bank of groove 106 is caulked, thereby fixing weight 104 to rotary shaft 102. Unbalance weight 104 is made of metal having a high specific gravity such as tungsten, and plated for rust prevention.

An operation of the conventional vibration motor is described hereinafter. The rotation of motor 101 rotates weight 104, and an unbalance gravity of weight 104 produces vibrations, thereby vibrating the entire motor. This vibration motor is mounted to a device, so that the entire device is vibrated for informing a user of a calling.

The structure discussed above; however, requires to caulk unbalance weight 104 to rotary shaft 102 strongly in order to increase the holding strength when weight 104 is mounted to rotary shaft 102. This strong caulking sometimes results in deforming rotary shaft 102. Further, as shown in FIG. 7, the caulking deforms caulking section 141, which causes an axial end face of weight 104 to swell. This swelling requires the unbalance weight per se to be smaller accordingly because the motor should be integrated into a small space of a device. The plating also increases a cost of the unbalance weight.

### SUMMARY OF THE INVENTION

The present invention addresses the problems discussed above, and aims to provide an inexpensive and small-size vibration motor producing greater vibrations and being strong against shocks.

The vibration motor of the present invention comprises the following elements:

an unbalance weight—provided to a rotary shaft—having a rest section for receiving the rotary shaft and a caulking section for caulking the weight to the rotary shaft; and

the rotary shaft having a recess at a place corresponding to the rest section. Caulking strength applied to the caulking section forces parts of the weight to bite the inside of the recess, thereby fixing the weight to the rotary shaft. This structure allows the rotary shaft to hold the weight tightly.

### BRIEF DESCRIPTION OF THE DRAWINGS

FIG. 1 is a perspective view of a vibration motor in accordance with a first exemplary embodiment of the present invention.

FIG. 2 is a sectional view of an unbalance weight of the vibration motor shown in FIG. 1.

FIG. 3 is a perspective view of a vibration motor in accordance with a second exemplary embodiment of the present invention.

FIG. 4 is a sectional view of an unbalance weight of a vibration motor in accordance with a third exemplary embodiment of the present invention.

FIG. 5 is a diagram comparing respective holding-strengths of an unbalance weight to a rotary shaft in the present invention and that of a conventional one.

FIG. 6 is a perspective view of a conventional vibration motor.

FIG. 7 is a sectional view of an unbalance weight of the motor shown in FIG. 6.

### DETAILED DESCRIPTION OF THE PREFERRED EMBODIMENTS

Exemplary embodiments of the present invention are demonstrated hereinafter with reference to the accompanying drawings.

(First Exemplary Embodiment)

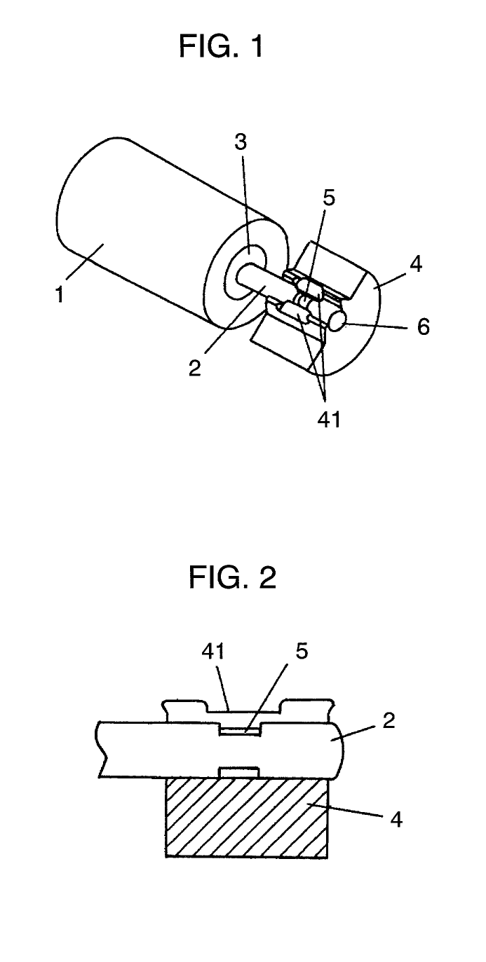

FIG. 1 is a perspective view of a vibration motor in accordance with the first exemplary embodiment of the present invention. FIG. 2 is a sectional view of an unbalance weight of the vibration motor shown in FIG. 1. In FIG. 1, rotary shaft 2 of motor 1 is journaled by bearing 3. Rotary shaft 2 has weight 4 at its tip, and weight 4 has axial groove 6, which functions as a rest section for receiving rotary shaft 2. In this first embodiment, recess 5 is provided to a part —corresponding to groove 6—of rotary shaft 2. Weight 4 includes caulking section 41 on the bank which forms groove 6. When weight 4 is fixed to rotary shaft 2, caulking strength applied to caulking section 41 forces parts of weight 4 to bite the inside of recess 5 formed on rotary shaft 2.

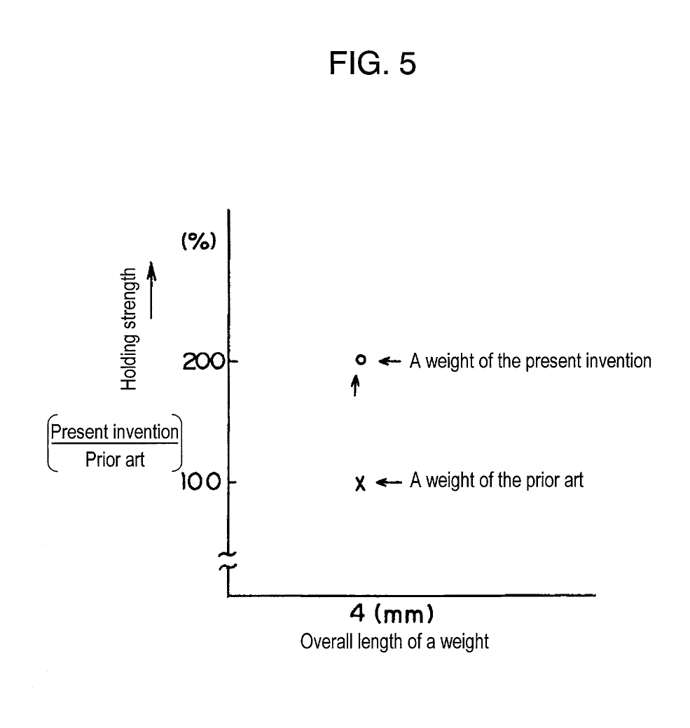

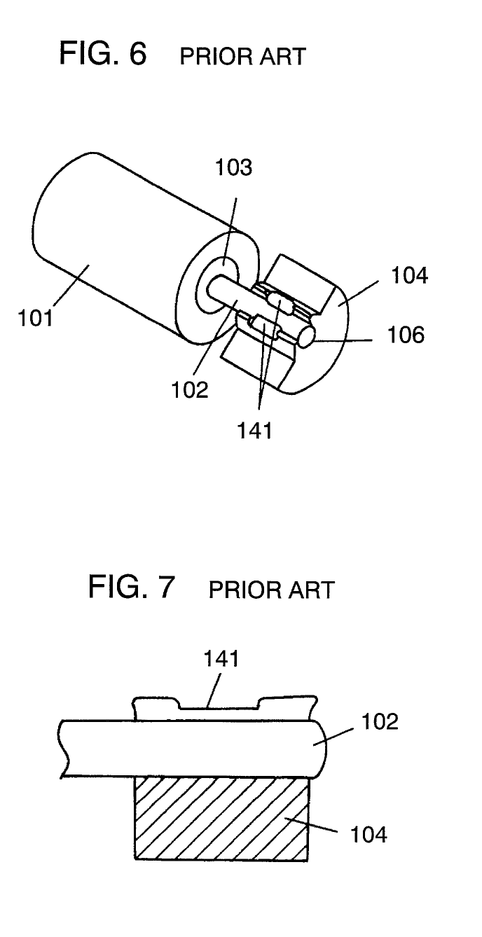

FIG. 5 is a diagram comparing respective holding-strengths of an unbalance weight to a rotary shaft in the present invention and that of a conventional one. As illustrated in FIG. 5, the strength of holding the weight according to the present invention is approx. doubled that of the conventional one.

(Second Exemplary Embodiment)

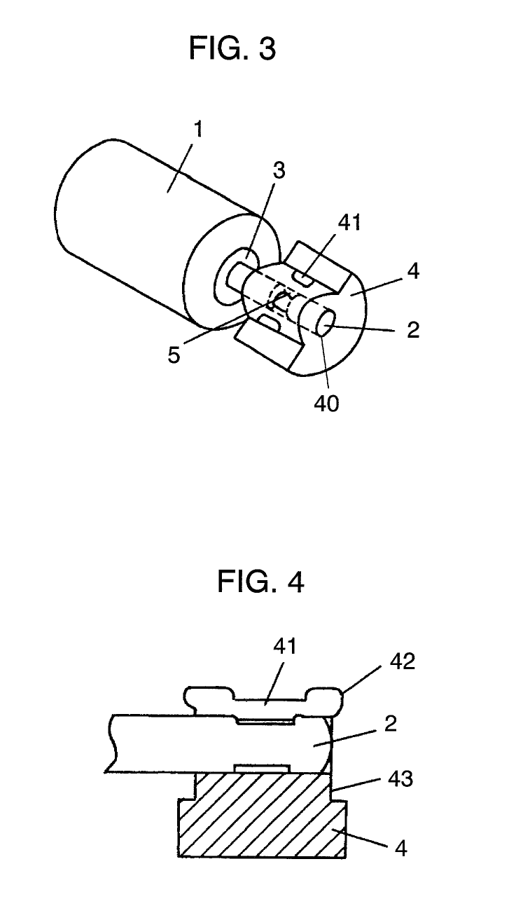

FIG. 3 is a perspective view of a vibration motor in accordance with the second exemplary embodiment of the present invention. The second embodiment differs from the first one in the following points: Hole 40 is formed on weight 4 in an axial direction of weight 4, and caulking section 41 is provided to weight 4. Hole 40 functions as a rest section through which rotary shaft 2 is inserted, and rotary shaft 2 has recess 5 at a place corresponding to hole 40. When weight 4 is fixed to rotary shaft 2, first, rotary shaft 2 is inserted into hole 40 of weight 4, then caulking strength applied to caulking section 41 forces parts of weight 4 to bite the inside of recess 5 of rotary shaft 2. This structure allows the rotary shaft to hold the weight tightly.

(Third Exemplary Embodiment)

FIG. 4 is a sectional view of an unbalance weight of a vibration motor in accordance with the third exemplary embodiment of the present invention. The third embodiment differs from the first one in the following points: Weight 4 has step 43 shaping in a recess on an axial end face, so that swelling section 42 does not overhang the axial end face of weight 4 when caulking section 41 is caulked to rotary shaft 2. This structure allows the motor in accordance with the third embodiment to hold the weight with the rotary shaft tightly and to be fit in a small space of a device.

(Fourth Exemplary Embodiment)

A vibration motor in accordance with the fourth embodiment has one of the structures of the first through third embodiments, and an unbalance weight of the motor has the following structure: The weight of the vibration motor in accordance with the fourth embodiment is mainly made of metal having a high specific gravity such as tungsten and formed by a sintering method, so that the weight has numbers of holes, which are to be impregnated with oil. As a result, as shown in table 1, the weight obtains much better rust prevention than other unbalance weights having no rust-proof preparation.

TABLE 1

| | Surface | | |
|---|---|---|---|
| | Treatment | 500 hours | 1000 hours |
| Weight 1 | nickel plating | no rust | no rust |
| Weight 2 | no plating | no rust | rusted |
| The weight of the | no plating | no rust | no rust |
| present invention | oil impregnated | | |

test condition: leave the samples in the atmosphere of 60° C., 90% RH the samples are made of tungsten 70%, copper 27% and nickel 3%.

The exemplary embodiments discussed previously prove that the present invention can increase substantially the strength of holding the weight with the rotary shaft of the vibration motor comparing with that of conventional ones. The embodiments also prove that the present invention can eliminate the surface treatment for rust prevention such as plating. Further, the structure, where a step is formed on an axial end face of the weight, prevents the swelling section due to caulking from overhanging the axial end face of the weight. Therefore, when the vibration motor of the present invention is disposed in the space where a conventional motor was disposed, the unbalance weight can be extended axially longer than the conventional one. As a result, the mass of the weight can be increased, whereby greater vibrations can be produced.

The present invention thus can provide an inexpensive motor having several advantages as discussed above, which satisfy demands from the market.

What is claimed is:

1. A vibration motor comprising:
an unbalance weight mounted to a rotary shaft, said weight including a rest section for receiving said rotary shaft and a caulking section for caulking said weight to said rotary shaft; and
said rotary shaft including a recess at a place corresponding to the rest section,
wherein caulking strength applied to the caulking section forces a part of said unbalance weight to bite inside of the recess for fixing said weight to said rotary shaft.

2. The vibration motor of claim 1, wherein the rest section is a groove formed on said weight in an axial direction.

3. The vibration motor of claim 2, wherein the caulking section is a bank which forms the groove.

4. The vibration motor of claim 1, wherein the rest section is a hole formed on said weight in an axial direction.

5. The vibration motor of claim 1, wherein a step is formed on an axial end face of said weight.

6. The vibration motor of claim 1, wherein said weight is made of oil-impregnated sintered metal of which major component is metal having a high specific gravity.

7. The vibration motor of claim 1, wherein said weight has one of a fan-shaped sectional view and a semicircular sectional view.
